(19) United States
(12) Patent Application Publication
(10) Pub. No.: US 2007/0219773 A1
(43) Pub. Date: Sep. 20, 2007

(54) Syntactic rule development graphical user interface

(75) Inventors: Claude Roux, Grenoble (FR); Gilbert Rondeau, Revel (FR); Vianney Grassaud, La Roquebrussanne (FR)

Correspondence Address: Patrick R. Roche;FAY, SHARPE, FAGAN, MINNICH & McKEE, LLP, SEVENTH FLOOR, 1100 SUPERIOR AVENUE, CLEVELAND, OH, 44114-2579, US

(73) Assignee: XEROX CORPORATION

(21) Appl. No.: 11/378,708

(22) Filed: Mar. 17, 2006

(51) Int. Cl. G06F 17/20

(52) U.S. Cl. 704/1

(57) ABSTRACT

A graphical user interface provides a rule editor which displays linguistic elements of a selected text string, such as in the form of a tree structure where words and phrases of the text string are represented by nodes. A processor generates a linguistic rule in accordance with those linguistic elements which are selected by the user on the rule editor.

### CROSS REFERENCE TO RELATED PATENTS AND APPLICATIONS

The following co-pending applications, the disclosures of which are incorporated in their entireties by reference, are mentioned:

U.S. application Ser. No. 11/173,136 (Attorney Docket No. 20041265-US-NP), filed Dec. 20, 2004, entitled CONCEPT MATCHING, by Agnes Sandor, et al.;

U.S. application Ser. No. 11/173,680 (Attorney Docket No. 20041302-US-NP), filed Dec. 20, 2004, entitled CONCEPT MATCHING SYSTEM, by Agnes Sandor, et al.;

U.S. application Ser. No. 11/287,170 (Attorney Docket No. 20050633-US-NP), filed Nov. 23, 2005, entitled CONTENT-BASED DYNAMIC EMAIL PRIORITIZER, by Caroline Brun, et al.;

U.S. application Ser. No. 11/202,549 (Attorney Docket No. 20041541-US-NP), filed Aug. 12, 2005, entitled DOCUMENT ANONYMIZATION APPARATUS AND METHOD, by Caroline Brun;

U.S. application Ser. No. 11/013,366 (Attorney Docket No. 20040610-US-NP), filed Dec. 15, 2004, entitled SMART STRING REPLACEMENT, by Caroline Brun, et al.;

U.S. application Ser. No. 11/018,758 (Attorney Docket No. 20040609-US-NP), filed Dec. 21, 2004, entitled BILINGUAL AUTHORING ASSISTANT FOR THE ‘TIP OF THE TONGUE’ PROBLEM, by Caroline Brun, et al.;

U.S. application Ser. No. 11/018,892 (Attorney Docket No. 20040117-US-NP), filed Dec. 21, 2004, entitled BI-DIMENSIONAL REWRITING RULES FOR NATURAL LANGUAGE PROCESSING, by Caroline Brun, et al.; and,

U.S. application Ser. No. 11/341,788 (Attorney Docket No. 20052100-US-NP), filed Jan. 27, 2006, entitled LINGUISTIC USER INTERFACE, by Frederique Segond, et al.

### BACKGROUND

The present exemplary embodiment relates generally to document processing. It finds particular application in conjunction with a system and a method for generating grammar rules for extracting facts from documents, and will be described with particular reference thereto. However, it is to be appreciated that the present exemplary embodiment is also amenable to other like applications.

The process of analyzing natural language inputs, such as words, sentences, paragraphs, and large texts implies the existence of a set of syntactic rules gathered into a so-called linguistic grammar. A linguistic grammar may comprise thousands of different rules, which all interact with each other. The input text may be indexed according to the rules. Sentences may be stored as a tree structure in which sub-rules are linked to syntactic nodes. The management of these rules can prove very difficult, as the modification of a rule may have complex side effects on the whole grammar. Further, the creation of new specialized rules is often a very difficult process, as the rules are usually created to recognize complex configurations of syntactic nodes, with heavy constraints.

### INCORPORATION BY REFERENCE

The following references, the disclosures of which are incorporated by reference in their entireties, are mentioned:

U.S. Pat. No. 6,405,162 entitled TYPE-BASED SELECTION OF RULES FOR SEMANTICALLY DISAMBIGUATING WORDS, by Segond, et al., discloses a method of semantically disambiguating words using rules derived from two or more types of information in a corpus which are applicable to words occurring in specified contexts. The method includes obtaining context information about a context in which a semantically ambiguous word occurs in an input text and applying the appropriate rule.

U.S. Pat. No. 6,678,677 to Roux, et al., discloses a method for information retrieval using a semantic lattice.

U.S. Pat. No. 6,263,335 to Paik, et al., discloses a system which identifies a predetermined set of relationships involving named entities.

U.S. Published Application No. 20030074187 entitled NATURAL LANGUAGE PARSER, by Ait-Mokhtar, et al. discloses a parser for syntactically analyzing an input string. The parser applies a plurality of rules which describe syntactic properties of the language of the input string.

U.S. Published Application No. 20050138556 entitled CREATION OF NORMALIZED SUMMARIES USING COMMON DOMAIN MODELS FOR INPUT TEXT ANALYSIS AND OUTPUT TEXT GENERATION, by Brun, et al. discloses a method for generating a reduced body of text from an input text by establishing a domain model of the input text; associating at least one linguistic resource with said domain model, analyzing the input text on the basis of the at least one linguistic resource, and based on a result of the analysis of the input text, generating the body of text on the basis of the at least one linguistic resource.

U.S. Published Application No. 20050137847 entitled METHOD AND APPARATUS FOR LANGUAGE LEARNING VIA CONTROLLED TEXTAUTHORING, by Brun, et al. discloses a method for testing a language learner's ability to create semantically coherent grammatical text in a language which includes displaying text in a graphical user interface, selecting from a menu of linguistic choices comprising at least one grammatically correct linguistic choice and at least one grammatically incorrect linguistic choice, and displaying an error message when a grammatically incorrect linguistic choice is selected.

### BRIEF DESCRIPTION

Aspects of the exemplary embodiment relate to a method, a system, and a computer program product for generating linguistic rules.

In one aspect, a method for generating a linguistic rule includes displaying linguistic elements of a selected text string in a rule editor, identifying linguistic elements selected by a user from the displayed linguistic elements, and generating a linguistic rule for the text string based on the linguistic elements selected by the user.

In another aspect, a system for generating syntactic rules includes a graphical user interface which displays a graphical rule editor, the rule editor enabling a user to select linguistic elements from displayed linguistic elements for a text string. A processor generates a syntactic rule on the basis of linguistic elements that are selected by the user.

In another aspect, a computer program product for use in a computer system for generating a syntactic rule includes a computer readable medium having a computer readable program code thereon. The computer readable program code causes the computer system to display linguistic elements of a user-selected text string in a rule editor. This enables a user to select linguistic elements and to generate a linguistic rule based on the linguistic elements selected by the user.

### BRIEF DESCRIPTION OF THE DRAWINGS

FIG. 1 illustrates a tree structure for an exemplary text string;

FIG. 2 is a block diagram of an exemplary interactive system for generating syntactic rules according to one aspect of the exemplary embodiment;

FIG. 3 illustrates a screen of the system of FIG. 2 showing a rule editor;

FIG. 4 is a flow diagram of an exemplary method for generating syntactic rules;

FIG. 5 illustrates a portion of the screen of FIG. 3 during the selection of linguistic elements;

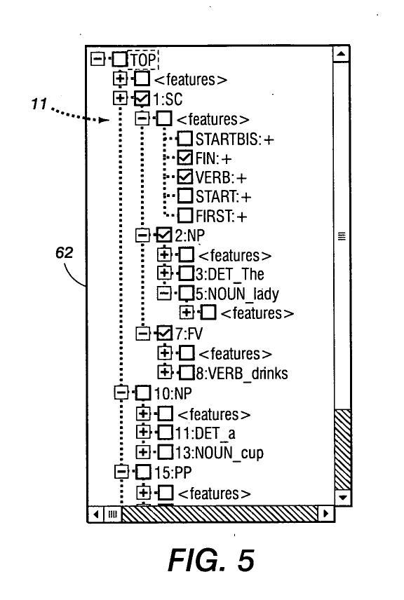

FIG. 6 illustrates a portion of the screen of FIG. 3 during the selection of linguistic elements in which a gap exists between higher level nodes;

FIG. 7 illustrates a portion of the screen of FIG. 3 in which a gap exists in the form of an unspecified node; and

FIG. 8 illustrates a portion of the screen of FIG. 3 in which a gap exists in the form of a higher level node.

### DETAILED DESCRIPTION

Aspects of the exemplary embodiment relate to a system comprising a graphical user interface which enables syntactic rules to be created by highlighting, e.g., with a mouse click, partially analyzed linguistic input. The system may be used by a grammarian for enriching a natural language grammar which can subsequently be used for annotating a corpus of documents with additional linguistic rules.

In various aspects a system for generating syntactic rules which can be applied to a natural language text string, such as a sentence, includes a graphical editor and an processor which generates a rule on the basis of linguistic elements (such as syntactic nodes, features, dependencies, and word forms) that are selected by a user. The graphical editor enables linguistic input to be analyzed step by step, with the possibility for a user to interact with the each of the structures generated at each stage.

The partially analyzed linguistic input may be in the form of an annotated text string that is retrieved from a corpus of natural language documents which have been annotated by a natural language parser.

In other aspects, a method of generating syntactic rules includes displaying linguistic elements of a text string on a graphical user interface whereby selected ones of the linguistic elements can be selected by a user. The user-selected linguistic elements are combined into a syntactic rule which can be used by a grammarian to develop new rules for enriching a grammar.

A syntactic rule may be considered as an expression, which may be based on one or more of the following linguistic elements:
1. The surface form, which is the character string that represents a word in a text (like dogs in “the dogs are happy”).
2. The lemma form, which is the base form of a word (dog is the lemma form of dogs in “the dogs are happy)
3. A set of syntactic nodes. A syntactic node may be a lexical category (such as noun, verb, adjective) or a phrasal category (such as a noun phrase (NP), verbal phrase (VP), adjectival phrase (AP), or prepositional phrase (PP)) in which words are grouped around a head. A head may be a noun, a verb, an adjective, or a preposition. Around these categories, the other minor categories, such as determiner, adverbs, pronouns etc. are lumped. The denotation noun, verb, NP, etc. are not mandatory and may change according to the linguist.
4. A set of features. A feature may be an attribute-value pair which is used to specialize syntactic nodes. For example, the notion of plural, singular is usually transcribed with a feature.
5. A set of dependencies. A dependency can be an n-ary relation that binds together one, two or more syntactic nodes. A dependency usually denotes a linguistic relationship between syntactic nodes such as a subject relation between a noun and a verb. Although the linguistically related words or phrases of a dependency may be next to each other in the sentence, they can be spaced by other words. For example, in the sentence, “the dogs are happy,” “the dogs” is a noun phrase and is the subject of the verb “are.” This relationship can be expressed as a dependency. Other dependencies include object-verb dependencies and verb-argument dependencies. The argument may be a locational argument, (e.g., for the sentence “I have been living in Paris,” the argument, “in Paris” is the locational argument of the verbal phrase “have been.” Or, the argument may be a temporal argument, such as “for ten years.”

In general, a syntactic rule includes one or more syntactic nodes. A syntactic rule is generally defined over a sentence or a shorter string of text.

The system relies on natural language processing (NLP) techniques to identify linguistic elements in a text string in a natural language, such as English. This function may be performed by a parser. The parser takes an XML or other text document as input and breaks each sentence linguistic elements of the type described above. The parser provides this functionality by applying a set of rules, called a grammar, dedicated to a particular natural language such as French, English, or Japanese. The grammar is written in the formal rule language, and describes the word or phrase configurations that the parser tries to recognize. The basic rule set used to parse basic documents in French, English, or Japanese is called the “core grammar.” The exemplary graphical user interface allows a grammarian to create new rules to add to such a core grammar.

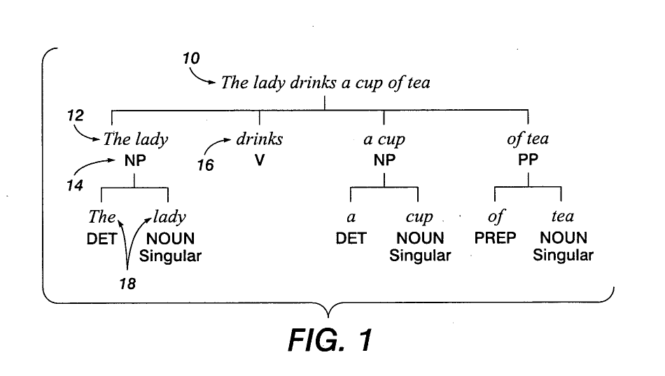

By way of example, FIG. 1 illustrates a text string 10 (“The lady drinks a cup of tea”) as a tree structure 12. Linguistic elements of a syntactic rule for this sentence may include one or more of syntactic nodes 14, 16, 18, etc. The highest level nodes, such as 14, 16, may be referred to as top nodes, with the nodes 18 depending from them referred to as sub-nodes. Some of the top nodes 16 may have no sub-nodes.

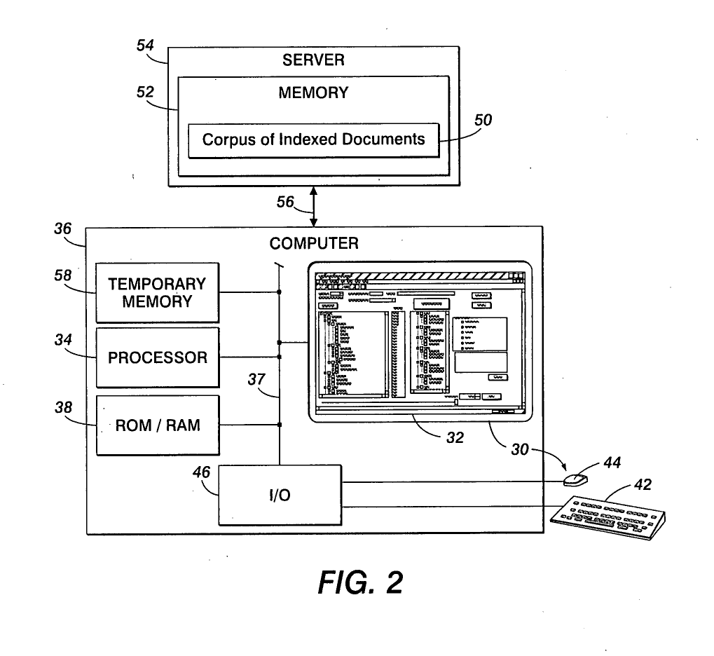

With reference to FIG. 2, an interactive system for generating linguistic rules for a text string 10 includes a graphical user interface (GUI) 30. The illustrated GUI provides a linguistic rule editor 32, which allows a user to select linguistic elements of interest, and a processor 34, which generates syntactic rules therefrom. The graphical user interface 30 may be embodied in a computer system 36, such as a PC, laptop, a dedicated device, or a mobile device, such as a personal digital assistant or cell phone. Alternatively, the processor 34 may be at a location remote from the linguistic rule editor 32, such as on a server for a network, and be in communication with the linguistic rule editor via a wireless or wired link.

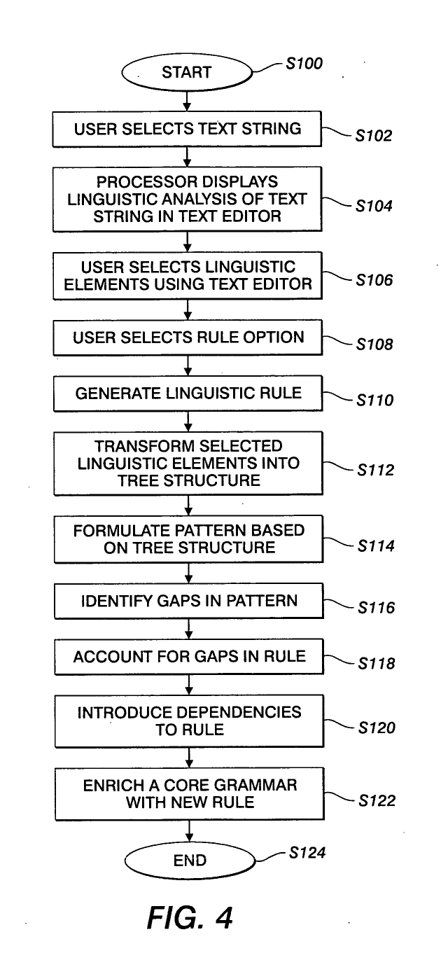

The processor 34 executes processing instructions for generating the syntactic rules based on user selection of linguistic elements. The processing instructions may be provided by a bus 37 from an associated internal memory 38. The internal memory 38 is typically a combination of Random Access Memory (RAM) and Read Only Memory (ROM). The processor 34 and the internal memory 38 may be discrete components or a single integrated device such as an Application Specification Integrated Circuit (ASIC) chip. The instructions may include instructions for performing each of the exemplary method steps outlined in FIG. 4. The instructions may be stored in a computer program product for use in the computer system 36. The computer program product may be a computer readable medium having a computer readable program code thereon. The computer readable program code, when executed by the processor 34, causing the computer system to display linguistic elements of a user-selected text string in the rule editor 32 which enables a user to select linguistic elements, and to cause the computer system to generate a linguistic rule for the text string based on the linguistic elements selected by the user.

The graphical user interface 30 may utilize the Windows® Operating System from Microsoft, Inc. or the Mac OS operating System from Apple Computer, Inc. Such graphical user interfaces have the characteristic that a user may interact with the computer system using a cursor control device and/or via a touch-screen display, rather than solely via keyboard input device. Such systems also have the characteristic that they may have multiple “windows” wherein discrete operating functions or applications may occur.

The illustrated computer includes a screen 40 such as an LCD display, for displaying the rule editor 32. A user interacts with the graphical user interface 30 by manipulation of one or more associated user input devices 42, 44, which communicate with the GUI via an input/output device 46. The user input device may include a text entry device 42, such as a keyboard, and/or a pointer 44, such as a mouse, track ball, pen, touch pad, touch screen, stylus, or the like. By manipulation of the user input device 40, 42 a user can enter text as well as navigate the screens and other features of the graphical user interface, such as one or more of a toolbar, pop-up windows, scrollbars (a graphical slider that can be set to horizontal or vertical positions along its length), menu bars (a list of options, which may be used to initiate actions presented in a horizontal list), pull downs (a list of options that can be used to present menu sub-options), and other features typically associated with GUIs. In the illustrated embodiment, the user input device 40 includes a keypad for inputting a text string, which may form a part of a user's query and a mouse 42 which can direct a cursor on the screen 40 and click on selected linguistic elements.

The processor 34 may retrieve text strings for editing with the rules editor 34 from a database 50. In the illustrated embodiment, the database 50 comprises a relational database which stores a corpus of documents, such as XML or text documents, the sentences of which have been indexed with tags according to at least some of the linguistic elements they contain, such as linguistic elements of the type outlined above. The database may be stored in memory 52 which may be located in the computer 36, or elsewhere, for example on a server 54 with a communication link 56 to the computer 36, as illustrated in FIG. 2. The indexing of the database documents may have been previously performed by a syntactic parser. Further details on the indexing will be provided below. During editing, the text string 10 and selected linguistic elements may be stored in a temporary memory 58 in the computer 36.

Alternatively, a text string which has not previously been analyzed by a parser may be input by the user and analyzed by the processor 34. In such instances, the processor may include at least a limited parsing capability.

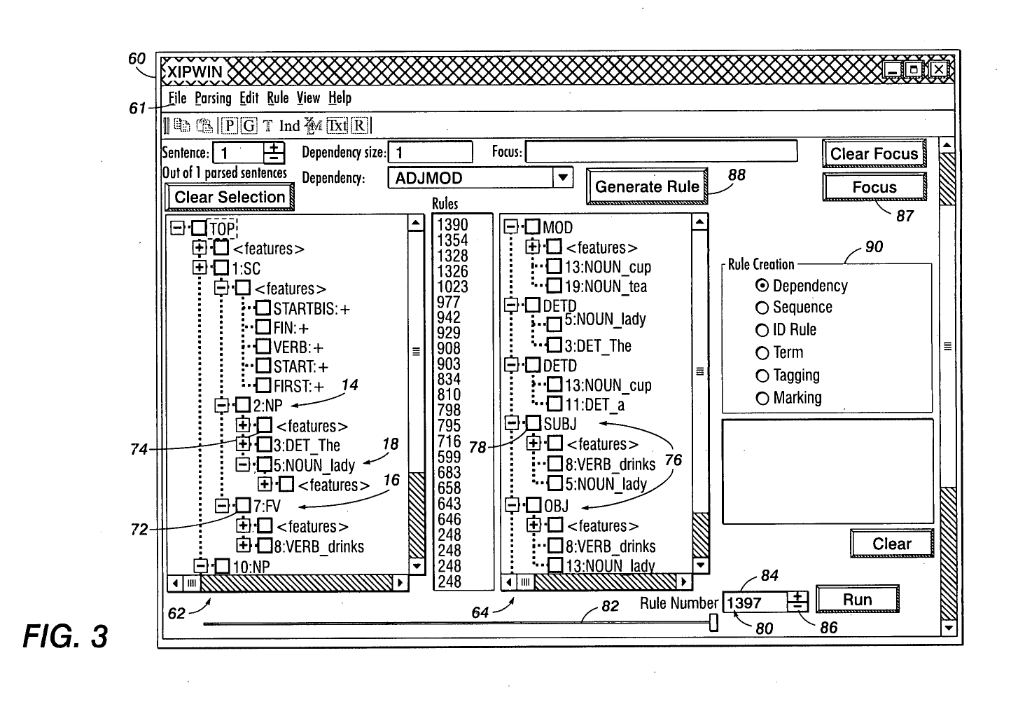

With reference now to FIG. 3, an exemplary rule editor 32 is illustrated as a window 60 on the display screen 40. A user may click on “file” 61 to retrieve a partially annotated document comprising the text string to be used to generate a rule. The processor 32 provides retrieved linguistic analysis of a selected text string to the rule editor 32. The rule editor 34 displays the linguistic analysis of the selected text string. The sentence (the lady drinks a cup of tea) has been analyzed to demonstrate the type of information which may be provided by the rule editor 32.

In the exemplary embodiment, the linguistic analysis of the text string is divided into two different views 62, 64, each corresponding to different types of analysis. The left view 62, or tree pane, corresponds to a linguistic tree of the analyzed sentence. Each node 14, 16, 18, etc. of the tree is user-selectable. Additionally, the user can also select features 68, etc. of each of the nodes 14, 16, 18, either together with the associated node or independently of the node. In the illustrated embodiment, each node 14, 16, 18 and feature 68 is associated with a user-selectable check box 72, 74, etc. by which a user can select a node or feature, e.g., by pointing and clicking the cursor. The right view 64, or dependency pane, corresponds to the dependencies extracted on the basis of the tree-like representation. This is specific to a so-called dependency parser, where a dependency is an n-ary relation between two or more syntactic nodes (i.e., n is an integer and is at least 2). Each dependency 76 is associated with a respective check box 78 and may include two or more linguistic elements from the tree.

Each linguistic element 14, 16, 18, 68, 76, etc. may be assigned a specific identifier 80, such as a number. In general, the numbers may be assigned generally in order from the top of the tree downward (as shown in FIG. 1). The identifier 80 can be selected either by moving a cursor on a slide-bar 82 at the bottom of the window, or by typing the number in an editing box 84, illustrated on the right of the screen. A “+,−” selector 86 can then be used to move to the next linguistic element or the previous one. The processor 34 creates a rule which applies all the linguistic elements up to the selected element number 80. This allows a user to select a specific state of the analysis, which can be used as a starting point for the creation and/or addition of new rules after the selected state of the analysis.

A user may click on a focus button 87. The system allows the grammarian to generate new rules, such as dependency rules. A dependency rule creates a “dependency”, (i.e. a syntactic function) which links two or more nodes from the chunk tree. The focus is the nodes from the chunk tree which the dependency rule will connect. For example, a rule such as:

NP{?*,Noun#1}, FV{?*,Verb#2}=SUBJECT(#2,#1)

builds a subject dependency between a noun (#1) and a verb (#2). These two nodes are sub-nodes of respectively a NP (Noun Phrase) and a VP {Verb Phrase}. The focus of the subject relation is the Noun and the Verb, respectively #1 and #2.

Once a user is satisfied with the selection of linguistic elements, the user clicks on a “generate rule” button 88.

The creation of syntactic rules will now be described with reference to FIG. 4. The method begins at step S100. At step S102, a user selects a text string, such as a sentence for analysis. The text string may be selected by the user by highlighting the string in a displayed portion of text, for example by operating the mouse 44. Or, the text string may be extracted from a file.

At step S104, the processor 34 retrieves the analysis of the text string, which may be stored along with the sentence in the database 50, and displays the analysis of the sentence in the rule editor 32. As noted above, each linguistic element (syntactic nodes, features, and dependencies) is associated with a checkbox, which can be individually selected. At step S106, a user checks one or more of the checkboxes to select the associated linguistic elements. The user may also select from a number of rule type options, the type of rule the user wants to create (step S108). By way of example, rule options such as Dependency, Sequence, ID Rule, Term, Tagging, and Marking are displayed in a rule options box 90 and can be selected by the user.

Once the user has selected all the linguistic information that he or she wants to use and the rule type, the user indicates that the selection is complete. At step S110, the processor 34 identifies the linguistic elements which have been selected by the user and applies processing instructions which generate a linguistic rule according to the selected linguistic element(s) and selected type of rule. The processing step S110 may include the substeps of transforming the selected linguistic expressions into a tree structure (substep S112), formulating a pattern based on the tree structure (substep S114), identifying gaps in the pattern (substep S116), accounting for the gaps in the syntactic rule (substep S118), and introducing dependencies to the rule (substep S120). The grammarian reviewing the linguistic representation can use it to formulate a new rule based on some or all of the information presented. The method may end here. Optionally, at step S122, the new rule, developed by the grammarian on the basis of a selected portion the linguistic representation, can be added to the core grammar to be used by a parser, such as the XIP parser, described below. The parser can then apply the new rules to index a corpus of documents. The text string 10 may thus be annotated with the new rule generated. The sentence 10, together with the enriched linguistic analysis, may be stored in the database 50.

The processing instructions, which are used by the processor 34 in the creation of a syntactic rule, may be assembled in an algorithm. The instructions take as input the selected linguistic elements. A primary input of this algorithm is the syntactic nodes which were selected on the tree panel and/or on the dependency panel. In the case of the dependency panel, the selection of a given dependency may automatically trigger the selection of the syntactic nodes on which this dependency is based.

The generated rule may have a pattern which follows the tree structure in a top-down manner—i.e., starting with the highest level nodes and working down, following the text from left to right. In the rule editor, a user may select any nodes or any features in any order; however the algorithm analyzes this selection according to the order in which these nodes occur along a top-down algorithm. This order determines the way the pattern is created. In one embodiment, the formalism used for the pattern may be that was developed for the Xerox Incremental Parser (XIP). The semantic of this formalism is the following:

| | |
|---|---|
| X | denotes a syntactic category 14, |
| [ . . . ] | denotes a feature structure 68, and |
| { . . . } | denotes syntactic sub-nodes 18. |

Exemplary syntactic categories are SC (sentence chunk), and phrases: NP (noun phrase), FV (verbal phrase) and PP (prepositional phrase). Exemplary feature structures are plural forms of the word. Exemplary syntactic sub-nodes 18 depend from the top nodes and can be NP (noun phrase), FV (verbal phrase) and PP (prepositional phrase) and NOUN, VERB, DET (determinator), PREP (preposition), and the like. Sub-nodes may in turn also have sub-nodes. This formalism is only used here as an example. The algorithm could be applied to generate other types of rules.

Three types of gaps may be identified at substep S116:
a) A gap between two top nodes 14—the processor 34 may automatically inset a gap character, such as “?*” to denote the presence of a non-limited number of nodes in between (including none).
b) A feature 68 has been chosen on a node 14, 16, 18, where the node itself has not been selected. In this case, the processor 34 may treat the non-selected node as having been selected but that its category does not matter. When a category is not mentioned in a rule, an unknown category character, such as “?” may be used to denote it.
c) A category of a top node 14 has not been selected, but a sub-node has. An unknown category character “?” on the top of the sub-nodes may be used to denote the non-selected category.

The last element of the algorithm (Step S120) may be the introduction in the rules of the selected dependencies. If a dependency has been selected in the right pane 64, a further constraint is added to the rule.

The rules generated by the method thus described may have two parts. A first part is the regular expression pattern which is generated as described above. A second part is a Boolean expression over the dependencies. This may be formalized by introducing the Boolean with an “if”. A link between the parameters of the dependency and the tree may be generated using a variable of the form: “#x” where x is a digit. Exemplary dependencies, which express a linguistic relationship between two or more nodes, are denoted as follows: MOD (a noun modifying a noun, such as cup and tea), DETD (a determinator and the noun it modifies), SUBJ (a noun and the verb of which it is the subject), OBJ (a verb and a noun which is the object of the verb), and PRED (a noun and a preposition which modifies it), and the like.

The concomitant use of the rules editor 32 with these simple expression patterns helps to generate some very complex rules on a simple succession of clicks.

As an example, suppose that a user has selected the nodes checked on the left panel of the editor shown in FIG. 4. The selected nodes are thus: SC, fin:+,verb:+, NP, FV. Note that fin:+ is used herein to represent the finite form of a verb).

At substep S112, this selection is transformed into a tree structure, having the same order as in the syntactic tree 11 shown in the pane 62 of the rule editor 32.

SC

Fin:+

Verb:+

NP

FV

The next step (S114) is to compute a pattern (a preliminary rule) out of this selection which identifies the selected categories, subnodes, and features, and the relationships between them:

SC[fin:+,verb:+]{NP,FV}.

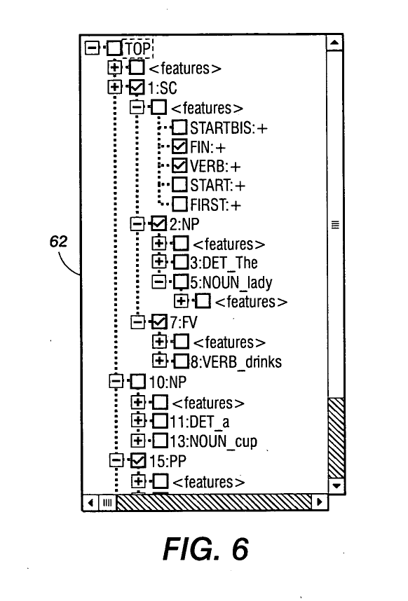

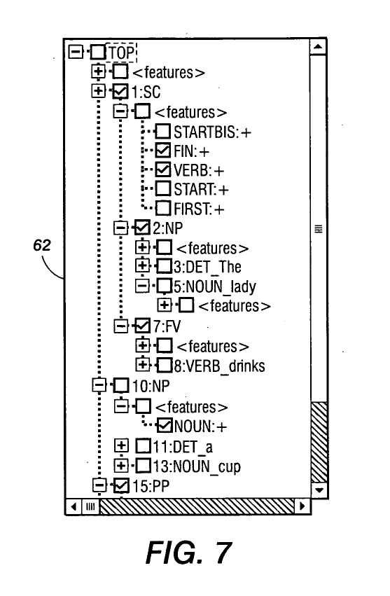

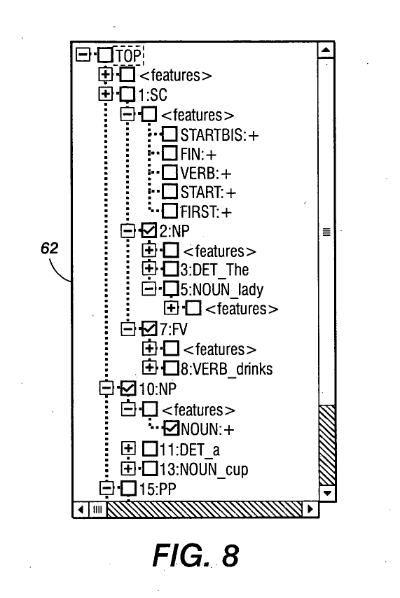

Since, the exemplary algorithm defines patterns on the basis of selected nodes; there may be some gaps in the selection. As illustrated in FIG. 6, for example, the node PP has been selected while the node NP before this has not. In another example shown in FIG. 7, the feature “Noun:+” has been selected, while the above super-node NP is not. In another example, a selection where nodes are selected at different depths in the tree is shown in FIG. 8.

In the first case, there is a gap between two top nodes SC and PP. The processor automatically inserts a “?*”, which corresponds to the presence of a non limited number of nodes in between. The processor will then produce the following pattern:

SC[fin:+,verb:+]{NP,FV}, ?*,PP

In the above pattern, the body of the rule-the words themselves, has been omitted for simplicity.

In the second case, there is a feature that has been chosen on a node which has not been selected. In this case, the system behaves as if this node had been selected but its category does not matter and inserts a “?” to denote it. The processor will then produce the following pattern:

SC[fin:+,verb:+]{NP,FV}, ?[Noun:+],PP

In the last case, there is a top category SC which is not mentioned. An unknown category is introduced on the top of the sub-nodes to solve the problem. The processor will then produce the following pattern:

?{NP,FV},NP

In the last processing substep (S120) dependencies are created. For example a rule such as:

|SC{NP#2,FV#1}| if (Subj(#1,#2)){ . . . }

may be triggered when a specific configuration of nodes is found where NP and FV nodes are linked with a “SUBJ” dependency. The body of the rule “{ . . . }” is not mentioned in this example.

In one embodiment, rules generated with the help of the linguistic user interface are used to enrich a core grammar of a parser which is used to index documents in a corpus of documents. The relationships between objects of the index may be stored using presence vectors as described, for example, in above-referenced U.S. Published Application No. 20050138000, which is incorporated herein by reference.

In some embodiments, the parser comprises an incremental parser, as described, for example, in above-referenced U.S. Patent Publication Nos. 20050138556 and 20030074187, which are incorporated herein by reference, and in the following references: Aït-Mokhtar, et al., “Incremental Finite-State Parsing,” Proceedings of Applied Natural Language Processing, Washington, April 1997; Aït-Mokhtar, et al., “Subject and Object Dependency Extraction Using Finite-State Transducers,” Proceedings ACL '97 Workshop on Information Extraction and the Building of Lexical Semantic Resources for NLP Applications, Madrid, July 1997; Aït-Mokhtar, et al., “Robustness Beyond Shallowness Incremental Dependency Parsing,” NLE Journal, 2002; and, Aït-Mokhtar, et al., “A Multi-input Dependency Parser,” in Proceedings of Beijing, IWPT 2001. One such parser is the Xerox Incremental Parser (XIP).

The parser may include processing instructions for executing various types of analysis of the text, such as identifying lemma forms, lexical and phrasal categories, features, and dependencies, and instructions for annotating the text string with tags, which are used to generate a tree structure. For example, the parser may include several modules for linguistic analysis. These modules may include a tokenizer module, which transforms input text into a sequence of tokens (words, punctuation, etc.), a lemmatizer, which identifies lemma forms of words, a morphological module, which associates lexical categories from a list of lexical categories, such as indefinite article, noun, verb, etc., with each recognized word in the text string, a chunking module, which identifies phrasal categories by grouping words around a head (a head may be a noun, a verb, an adjective, or a preposition) and a dependency module, which identifies dependencies between lexical categories and/or phrasal categories. It will be appreciated that functions of these modules may be combined as a single unit or that different modules may be utilized. Each module works on the input text, and in some cases, uses the annotations generated by one of the other modules, and the results of all the modules are used to annotate the input text string. Thus, several different grammar rules may eventually be applied to the same text string. It will be appreciated that a parser may have fewer, more, or different modules than those described herein. An exemplary parser includes components, or modules, which work on an input text.

The processor 34 may include components of such a parser or may operate on text which has already been analyzed by such a parser.

The system finds application in the development of a search engine having the capability for extracting document parts that contain only the relevant information. This type of information extraction comprises both the extraction of information and its storage in relational or semi structured databases for further easy retrieval within the context of different applications. This enables a more focused fact extraction, rather than simply information extraction. Fact extraction is the subpart of information extraction that concentrates on the extraction of information from textual documents. Fact extraction is one aspect of semantics and its use relies on decoding the meaning of relations that link words together. In fact extraction, first the words are extracted, then the relations between them. The ultimate goal of fact extraction is to obtain responsive answers to queries.

The exemplary system provides a user interface that enables experienced and inexperienced users to define new fact extraction rules from texts easily and transparently. It allows new rules to be added to a text corpus or to a parser simply and efficiently. Rules which are found to be wrong or missing from the parser can easily be modified or added. New users can easily be trained to use the system since their exact behavior can be demonstrated at a click.

The interface may be designed to create specific rules which can be used to annotate documents in a database and which allow subsequent users to retrieve documents responsive to the rules. For example, a user may be interested in identifying documents which include sentences about what a particular person (Mr. Smith) said about China. The user may have retrieved the sentence “Mr. Smith often said that he would like to visit China.” By creating a rule which identifies “Mr. Smith” as the subject and “said” as the verb in a dependency relationship, and “Mr. Smith” and “China” in a subject:object dependency, documents in a database can be indexed according to this highly specific rule. The database can then be searched by a user to identify other documents which make reference to what Mr. Smith said about China. By expanding the rule to include sentences in which the words have the same lemma form as “said” in the rule, a sentence such as “Mr. Smith, in an interview tomorrow, will say that he will be visiting China next month” could be retrieved. The user does not need to be able to identify all the linguistic elements that he wishes to express with the rule since the rule editor provides the linguistic elements in the context of the sentence.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method for generating a linguistic rule comprising:
displaying linguistic elements of a selected text string in a rule editor;
identifying linguistic elements selected from the displayed linguistic elements by a user;
generating a linguistic rule for the text string based on the linguistic elements selected by the user.

2. The method of claim 1, wherein the text string comprises a sentence.

3. The method of claim 1, wherein the selected text string is annotated with linguistic elements, the method further comprising, prior to the displaying of linguistic elements, retrieving the linguistic elements for the selected text string.

4. The method of claim 1, wherein the rule editor is provided by a graphical user interface.

5. The method of claim 1, further comprising:
inputting user selections of linguistic elements via a user input device associated with the graphical user interface.

6. The method of claim 1, wherein the displaying of the linguistic elements includes displaying at least some of the linguistic elements as a tree structure.

7. The method of claim 5, wherein the linguistic elements are associated in the tree structure with user-selectable check boxes.

8. The method of claim 1, wherein the linguistic elements are selected from the group consisting of:
a syntactic node;
a feature which specializes a syntactic node; and
a dependency which denotes a linguistic relationship between at least two syntactic nodes.

9. The method of claim 8, wherein the syntactic node is selected from a lexical category and a phrasal category.

10. The method of claim 8, wherein the generating a linguistic rule for the text string comprises:
transforming the selected linguistic elements into a tree structure;
identifying any gaps in the tree structure and accounting for any such gaps in the generated rule; and
where the selected linguistic elements include dependencies, incorporating the dependencies into to the rule.

11. The method of claim 10, wherein the gaps correspond to at least one of:
at least one gap between two syntactic nodes;
a non-selected node where its feature has been selected; and
a non-selected category of a syntactic node.

12. A system for generating syntactic rules comprising;
a graphical user interface which displays a graphical rule editor, the rule editor enabling a user to select linguistic elements from displayed linguistic elements for a text string; and
a processor which generates a syntactic rule on the basis of linguistic elements that are selected by the user.

13. The system of claim 12, further comprising a memory which stores text strings annotated with corresponding linguistic elements.

14. The system of claim 12, further comprising:
a user input device associated with the graphical user interface which enables a user to select linguistic elements in the text editor.

15. The system of claim 12, wherein the rule editor displays at least some of the linguistic elements as a tree structure.

16. The system of claim 15, wherein the syntactic rule is ordered according to the tree structure.

17. The system of claim 12, wherein the linguistic elements are associated in the tree structure with user-selectable check boxes.

18. The system of claim 12, wherein the linguistic elements are selected from the group consisting of
a syntactic node;
a feature which specializes a syntactic node; and
a dependency which denotes a relationship between at least two syntactic nodes.

19. The system of claim 18, wherein linguistic elements displayed in the rule editor include syntactic nodes and dependencies between at least two syntactic nodes.

20. The system of claim 12, wherein the rule editor includes a rule identifier selector for enabling a user to select a linguistic element by its associated rule identifier.

21. A system for performing the method of claim 1.

22. A computer program product for use in a computer system for generating a syntactic rule, the computer program product comprising a computer readable medium having a computer readable program code thereon, the computer readable program code causing the computer system to display linguistic elements of a user-selected text string in a rule editor which enables a user to select linguistic elements and to generate a linguistic rule based on the linguistic elements selected by the user.
